(19) United States
(12) Patent Application Publication
(10) Pub. No.: US 2018/0150306 A1
(43) Pub. Date: May 31, 2018

(54) SYSTEMS AND METHODS FOR ELIMINATING REBOOT DURING INITIAL MACHINE CONFIGURATION OF OPERATING SYSTEMS

(71) Applicant: Microsoft Technology Licensing, LLC, Redmond, WA (US)

(72) Inventors: Naga GOVINDARAJU, Redmond, WA (US); Md. Daud Hossain HOWLADER, Bothell, WA (US); Sushant Pramod REWASKAR, Redmond, WA (US); Christopher Warner MCCARRON, Hartford, CT (US); Santanu CHAKRABORTY, Sammamish, WA (US); Jiangtian LI, Bellevue, WA (US); Murtaza Muidul Huda CHOWDHURY, Sammamish, WA (US)

(21) Appl. No.: 15/598,889

(22) Filed: May 18, 2017

Related U.S. Application Data
(60) Provisional application No. 62/427,527, filed on Nov. 29, 2016.

(51) Int. Cl. G06F 9/445; G06F 9/44; G06F 11/14; G06F 9/50

(52) U.S. Cl. CPC G06F 9/44505; G06F 9/4406; G06F 2009/45575; G06F 11/1417; G06F 9/5016; G06F 9/4416

(57) ABSTRACT

A system is configured to boot an image of an operating system for creating a virtual machine to run the operating system, and to eliminate a reboot from occurring, before the image completes booting and before the created virtual machine begins running the operating system, by provisioning the image with configuration settings associated with the virtual machine during the booting of the image.

### CROSS-REFERENCE TO RELATED APPLICATIONS

This application claims the benefit of U.S. Provisional Application No. 62/427,527, filed on Nov. 29, 2016. The entire disclosure of the application referenced above is incorporated herein by reference.

### FIELD

The present disclosure relates to systems and methods for eliminating reboot during initial machine configuration of operating systems to specialize deployment instances while deploying from general images.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

An image of an operating system (OS) is typically used to install the operating system on one or more computers. During installation on a computer, while the image boots for the first time on the computer, many machine-specific configuration settings (e.g., computer name, page file location, etc.) are supplied to the image. The image reboots to apply these machine-specific configuration settings before the installation of the operating system on the computer can be completed. Additionally, while the image boots for the first time on the computer, the image captures information about hardware devices installed on the computer (e.g., disk drive, network interface card, etc.). Subsequently, the image loads corresponding device drivers and reboots before the installation of the operating system on the computer can be completed. The image may also reboot during the installation process to load any non-whitelisted services (a whitelisted service is a service for which rebooting the operating service is unnecessary while the initial boot is in progress). Accordingly, because the configuration changes and/or a non-whitelisted service starts, the operating system reboots during the installation process before the installation process finishes and before the operating system is ready for use on the computer.

### SUMMARY

A system comprises a processor and memory, and machine readable instructions stored in the memory. When executed by the processor, the machine readable instructions are configured to (i.e., the machine readable instructions configure the system to) boot an image of an operating system for creating a virtual machine to run the operating system and eliminate a reboot from occurring, before the image completes booting and before the created virtual machine begins running the operating system, by provisioning the image with configuration settings associated with the virtual machine during the booting of the image.

In other features, the configuration settings include a name for the virtual machine, a location for a page file associated with the virtual machine, and a storage area network policy associated with the virtual machine.

In other features, the machine readable instructions are configured to, prior to booting the image of the operating system, generate a file based on the configuration settings associated with the virtual machine and inject the file into the virtual machine. The machine readable instructions are configured to provision the image with the configuration settings from the file during the booting of the image.

In other features, the machine readable instructions are configured to, prior to booting the image of the operating system, generate a file based on the configuration settings associated with the virtual machine, store the file on a disk, and attach the disk to the virtual machine. The machine readable instructions are configured to provision the image with the configuration settings from the file stored on the disk attached to the virtual machine during the booting of the image.

In other features, the machine readable instructions are configured to, prior to booting the image of the operating system, generate a file based on the configuration settings associated with the virtual machine, create a basic input/output device on the virtual machine, and store the file on the basic input/output device on the virtual machine. The machine readable instructions are configured to provision the image with the configuration settings from the file stored on the basic input/output device on the virtual machine during the booting of the image.

In other features, the machine readable instructions are configured to receive the image prepared with device information associated with the virtual machine. The device information includes information about a hard disk drive and a network interface card associated with the virtual machine. The image includes device drivers according to the device information. The image prepared with device information eliminates device discovery and a subsequent reboot from occurring during the booting of the image.

In other features, the machine readable instructions are configured to prevent a service other than predetermined services from starting during the booting of the image to prevent the service from triggering an additional reboot during the booting of the image.

In other features, the machine readable instructions are configured to receive the image prepared with device information associated with the virtual machine to eliminate device discovery and a subsequent reboot from occurring during the booting of the image. The machine readable instructions are configured to prevent a service other than predetermined services from starting during the booting of the image to prevent the service from triggering an additional reboot during the booting of the image.

In still other features, a method comprises booting an image of an operating system for creating a virtual machine to run the operating system, and eliminating a reboot from occurring, before the image completes booting and before the created virtual machine begins running the operating system, by provisioning the image with configuration settings associated with the virtual machine during the booting of the image.

In other features, the configuration settings include a name for the virtual machine, a location for a page file associated with the virtual machine, and a storage area network policy associated with the virtual machine.

In other features, the method further comprises, prior to booting the image of the operating system, generating a file based on the configuration settings associated with the virtual machine, and injecting the file into the virtual machine. The method further comprises provisioning the image with the configuration settings from the file during the booting of the image.

In other features, the method further comprises, prior to booting the image of the operating system, generating a file based on the configuration settings associated with the virtual machine, storing the file on a disk, and attaching the disk to the virtual machine. The method further comprises provisioning the image with the configuration settings from the file stored on the disk attached to the virtual machine during the booting of the image.

In other features, the method further comprises, prior to booting the image of the operating system, generating a file based on the configuration settings associated with the virtual machine, creating a basic input/output device on the virtual machine, and storing the file on the basic input/output device on the virtual machine. The method further comprises provisioning the image with the configuration settings from the file stored on the basic input/output device on the virtual machine during the booting of the image.

In other features, the method further comprises receiving the image prepared with device information associated with the virtual machine. The device information includes information about a hard disk drive and a network interface card associated with the virtual machine. The image includes device drivers according to the device information. The image prepared with device information eliminates device discovery and a subsequent reboot from occurring during the booting of the image.

In other features, the method further comprises preventing a service other than predetermined services from starting during the booting of the image to prevent the service from triggering an additional reboot during the booting of the image.

In other features, the method further comprises receiving the image prepared with device information associated with the virtual machine to eliminate device discovery and a subsequent reboot from occurring during the booting of the image. The method further comprises preventing a service other than predetermined services from starting during the booting of the image to prevent the service from triggering an additional reboot during the booting of the image.

In still other features, a system comprises a processor and memory, and machine readable instructions stored in the memory. When executed by the processor, the machine readable instructions are configured to (i.e., the machine readable instructions configure the system to), prior to booting an image of an operating system for creating a virtual machine to run the operating system, generate a file based on configuration settings associated with the virtual machine, and inject the file into the virtual machine. The configuration settings include a name for the virtual machine, a location for a page file associated with the virtual machine, and a storage area network policy associated with the virtual machine. The machine readable instructions are further configured to provision the image with the configuration settings from the file during booting of the image to eliminate a reboot from occurring before the image completes booting and before the created virtual machine begins running the operating system.

In other features, the machine readable instructions are configured to, prior to booting the image of the operating system, store the file on a disk, and attach the disk to the virtual machine. The machine readable instructions are further configured to provision the image with the configuration settings from the file stored on the disk attached to the virtual machine during the booting of the image.

In other features, the machine readable instructions are configured to, prior to booting the image of the operating system, create a basic input/output device on the virtual machine, and store the file on the basic input/output device on the virtual machine. The machine readable instructions are further configured to provision the image with the configuration settings from the file stored on the basic input/output device on the virtual machine during the booting of the image.

In other features, the machine readable instructions are configured to receive the image prepared with device information associated with the virtual machine to eliminate device discovery and a subsequent reboot from occurring during the booting of the image. The machine readable instructions are further configured to prevent a service other than predetermined services from starting during the booting of the image to prevent the service from triggering an additional reboot during the booting of the image.

In still other features, a system comprises a processor and memory, and machine readable instructions stored in the memory. When executed by the processor, the machine readable instructions are configured to (i.e., the machine readable instructions configure the system to) receive an image of an operating system for creating a virtual machine to run the operating system. The image is prepared with device information associated with the virtual machine. The machine readable instructions are further configured to boot the image to create the virtual machine. The image prepared with device information associated with the virtual machine eliminates a reboot from occurring before the image completes booting and before the created virtual machine begins running the operating system.

In other features, the device information includes information about a hard disk drive and a network interface card associated with the virtual machine. The image includes device drivers according to the device information.

In other features, the machine readable instructions are configured to eliminate an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In other features, the machine readable instructions are configured to, prior to booting the image of the operating system, generate a file based on configuration settings associated with the virtual machine, and inject the file into the virtual machine. The configuration settings include a name for the virtual machine, a location for a page file associated with the virtual machine, and a storage area network policy associated with the virtual machine. The machine readable instructions are further configured to provision the image with the configuration settings from the file during the booting of the image to eliminate an additional reboot from occurring before the image completes booting and before the created virtual machine begins running the operating system.

In other features, the machine readable instructions are configured to, prior to booting the image of the operating system, generate a file based on configuration settings associated with the virtual machine, store the file on a disk, and attach the disk to the virtual machine. The configuration settings include a name for the virtual machine, a location for a page file associated with the virtual machine, and a storage area network policy associated with the virtual machine. The machine readable instructions are further configured to provision the image with the configuration settings from the file stored on the disk attached to the virtual machine during the booting of the image to eliminate an additional reboot from occurring before the image completes booting and before the created virtual machine begins running the operating system.

In other features, the machine readable instructions are configured to, prior to booting the image of the operating system, generate a file based on configuration settings associated with the virtual machine, create a basic input/output device on the virtual machine, and store the file on the basic input/output device on the virtual machine. The configuration settings include a name for the virtual machine, a location for a page file associated with the virtual machine, and a storage area network policy associated with the virtual machine. The machine readable instructions are further configured to provision the image with the configuration settings from the file stored on the basic input/output device on the virtual machine during the booting of the image to eliminate an additional reboot from occurring before the image completes booting and before the created virtual machine begins running the operating system.

In other features, the machine readable instructions are configured to prevent a service other than predetermined services from starting during the booting of the image to prevent the service from triggering an additional reboot during the booting of the image.

In other features, the machine readable instructions are configured to eliminate an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine. The machine readable instructions are further configured to prevent a service other than predetermined services from starting during the booting of the image to prevent the service from triggering a further reboot during the booting of the image.

In still other features, a method comprises receiving an image of an operating system for creating a virtual machine to run the operating system. The image is prepared with device information associated with the virtual machine. The method further comprises booting the image to create the virtual machine. The image prepared with device information associated with the virtual machine eliminates a reboot from occurring before the image completes booting and before the created virtual machine begins running the operating system.

In other features, the device information includes information about a hard disk drive and a network interface card associated with the virtual machine. The image includes device drivers according to the device information.

In other features, the method further comprises eliminating an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In other features, the method further comprises, prior to booting the image of the operating system, generating a file based on configuration settings associated with the virtual machine, and injecting the file into the virtual machine. The configuration settings include a name for the virtual machine, a location for a page file associated with the virtual machine, and a storage area network policy associated with the virtual machine. The method further comprises provisioning the image with the configuration settings from the file during the booting of the image to eliminate an additional reboot from occurring before the image completes booting and before the created virtual machine begins running the operating system.

In other features, the method further comprises, prior to booting the image of the operating system, generating a file based on configuration settings associated with the virtual machine, storing the file on a disk, and attaching the disk to the virtual machine. The configuration settings include a name for the virtual machine, a location for a page file associated with the virtual machine, and a storage area network policy associated with the virtual machine. The method further comprises provisioning the image with the configuration settings from the file stored on the disk attached to the virtual machine during the booting of the image to eliminate an additional reboot from occurring before the image completes booting and before the created virtual machine begins running the operating system.

In other features, the method further comprises, prior to booting the image of the operating system, generating a file based on configuration settings associated with the virtual machine, creating a basic input/output device on the virtual machine, and storing the file on the basic input/output device on the virtual machine. The configuration settings include a name for the virtual machine, a location for a page file associated with the virtual machine, and a storage area network policy associated with the virtual machine. The method further comprises provisioning the image with the configuration settings from the file stored on the basic input/output device on the virtual machine during the booting of the image to eliminate an additional reboot from occurring before the image completes booting and before the created virtual machine begins running the operating system.

In other features, the method further comprises preventing a service other than predetermined services from starting during the booting of the image to prevent the service from triggering an additional reboot during the booting of the image.

In other features, the method further comprises eliminating an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine. The method further comprises preventing a service other than predetermined services from starting during the booting of the image to prevent the service from triggering a further reboot during the booting of the image.

In still other features, a system comprises a processor and memory, and machine readable instructions stored in the memory. When executed by the processor, the machine readable instructions are configured to (i.e., the machine readable instructions configure the system to) receive an image of an operating system for creating a virtual machine to run the operating system. The image is prepared with device information associated with the virtual machine. The image includes device drivers according to the device information. The machine readable instructions are further configured to boot the image to create the virtual machine. The image prepared with device information associated with the virtual machine eliminates a reboot from occurring before the image completes booting and before the created virtual machine begins running the operating system.

In other features, the machine readable instructions are configured to, prior to booting the image of the operating system, generate a file based on configuration settings associated with the virtual machine, and inject the file into the virtual machine. The configuration settings include a name for the virtual machine, a location for a page file associated with the virtual machine, and a storage area network policy associated with the virtual machine. The machine readable instructions are further configured to provision the image with the configuration settings from the file during the booting of the image to eliminate an additional reboot from occurring before the image completes booting and before the created virtual machine begins running the operating system.

In other features, the machine readable instructions are configured to prevent a service other than predetermined services from starting during the booting of the image to prevent the service from triggering an additional reboot during the booting of the image.

In other features, the machine readable instructions are configured to eliminate an additional reboot from occurring, before the image completes booting and before the created virtual machine begins running the operating system, by provisioning the image with configuration settings associated with the virtual machine during the booting of the image. The machine readable instructions are further configured to prevent a service other than predetermined services from starting during the booting of the image to prevent the service from triggering a further reboot during the booting of the image.

In still other features, a system comprises a processor and memory, and machine readable instructions stored in the memory. When executed by the processor, the machine readable instructions are configured to (i.e., the machine readable instructions configure the system to) receive an image of an operating system for creating a virtual machine to run the operating system, boot the image to create the virtual machine, and eliminate a reboot from occurring, before the image completes booting and before the created virtual machine begins running the operating system, by preventing a service other than predetermined services from starting during the booting of the image.

In other features, machine readable instructions are configured to prevent the service other than predetermined services from starting during the booting of the image by delaying the start of the service after the image completes booting and after the created virtual machine begins running the operating system.

In other features, the machine readable instructions are configured to eliminate an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In other features, the machine readable instructions are configured to, prior to booting the image of the operating system, generate a file based on configuration settings associated with the virtual machine, and inject the file into the virtual machine. The configuration settings include a name for the virtual machine, a location for a page file associated with the virtual machine, and a storage area network policy associated with the virtual machine. The machine readable instructions are further configured to provision the image with the configuration settings from the file during the booting of the image to eliminate an additional reboot from occurring before the image completes booting and before the created virtual machine begins running the operating system.

In other features, the machine readable instructions are configured to, prior to booting the image of the operating system, generate a file based on configuration settings associated with the virtual machine, store the file on a disk, and attach the disk to the virtual machine. The configuration settings include a name for the virtual machine, a location for a page file associated with the virtual machine, and a storage area network policy associated with the virtual machine. The machine readable instructions are further configured to provision the image with the configuration settings from the file stored on the disk attached to the virtual machine during the booting of the image to eliminate an additional reboot from occurring before the image completes booting and before the created virtual machine begins running the operating system.

In other features, the machine readable instructions are configured to, prior to booting the image of the operating system, generate a file based on configuration settings associated with the virtual machine, create a basic input/output device on the virtual machine, and store the file on the basic input/output device on the virtual machine. The configuration settings include a name for the virtual machine, a location for a page file associated with the virtual machine, and a storage area network policy associated with the virtual machine. The machine readable instructions are further configured to provision the image with the configuration settings from the file stored on the basic input/output device on the virtual machine during the booting of the image to eliminate an additional reboot from occurring before the image completes booting and before the created virtual machine begins running the operating system.

In other features, the machine readable instructions are configured to receive the image prepared with device information associated with the virtual machine. The device information includes information about a hard disk drive and a network interface card associated with the virtual machine. The image includes device drivers according to the device information. The image prepared with device information eliminates device discovery and a subsequent reboot from occurring during the booting of the image.

In other features, the machine readable instructions are configured to receive the image prepared with device information associated with the virtual machine to eliminate device discovery and a subsequent reboot from occurring during the booting of the image. The device information includes information about a hard disk drive and a network interface card associated with the virtual machine. The image includes device drivers according to the device information. The machine readable instructions are further configured to eliminate an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In still other features, a method comprises receiving an image of an operating system for creating a virtual machine to run the operating system, booting the image to create the virtual machine, and eliminating a reboot from occurring, before the image completes booting and before the created virtual machine begins running the operating system, by preventing a service other than predetermined services from starting during the booting of the image.

In other features, the method further comprises preventing the service other than predetermined services from starting during the booting of the image by delaying the start of the service after the image completes booting and after the created virtual machine begins running the operating system.

In other features, the method further comprises eliminating an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In other features, the method further comprises, prior to booting the image of the operating system, generating a file based on configuration settings associated with the virtual machine, and injecting the file into the virtual machine. The configuration settings include a name for the virtual machine, a location for a page file associated with the virtual machine, and a storage area network policy associated with the virtual machine. The method further comprises provisioning the image with the configuration settings from the file during the booting of the image to eliminate an additional reboot from occurring before the image completes booting and before the created virtual machine begins running the operating system.

In other features, the method further comprises, prior to booting the image of the operating system, generating a file based on configuration settings associated with the virtual machine, storing the file on a disk, and attaching the disk to the virtual machine. The configuration settings include a name for the virtual machine, a location for a page file associated with the virtual machine, and a storage area network policy associated with the virtual machine. The method further comprises provisioning the image with the configuration settings from the file stored on the disk attached to the virtual machine during the booting of the image to eliminate an additional reboot from occurring before the image completes booting and before the created virtual machine begins running the operating system.

In other features, the method further comprises, prior to booting the image of the operating system, generating a file based on configuration settings associated with the virtual machine, creating a basic input/output device on the virtual machine, and storing the file on the basic input/output device on the virtual machine. The configuration settings include a name for the virtual machine, a location for a page file associated with the virtual machine, and a storage area network policy associated with the virtual machine. The method further comprises provisioning the image with the configuration settings from the file stored on the basic input/output device on the virtual machine during the booting of the image to eliminate an additional reboot from occurring before the image completes booting and before the created virtual machine begins running the operating system.

In other features, the method further comprises receiving the image prepared with device information associated with the virtual machine. The device information includes information about a hard disk drive and a network interface card associated with the virtual machine. The image includes device drivers according to the device information. The image prepared with device information eliminates device discovery and a subsequent reboot from occurring during the booting of the image.

In other features, the method further comprises receiving the image prepared with device information associated with the virtual machine to eliminate device discovery and a subsequent reboot from occurring during the booting of the image. The device information includes information about a hard disk drive and a network interface card associated with the virtual machine. The image includes device drivers according to the device information. The method further comprises eliminating an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

In still other features, a system comprises a processor and memory, and machine readable instructions stored in the memory. When executed by the processor, the machine readable instructions are configured to (i.e., the machine readable instructions configure the system to) receive an image of an operating system for creating a virtual machine to run the operating system and boot the image to create the virtual machine. The machine readable instructions are further configured to eliminate a reboot from occurring, before the image completes booting and before the created virtual machine begins running the operating system, by one or more of not enabling services other than predetermined services during the booting of the image and delaying start of the services other than the predetermined services after the image completes booting and after the created virtual machine begins running the operating system.

In other features, the machine readable instructions are configured to, prior to booting the image of the operating system, generate a file based on configuration settings associated with the virtual machine, and inject the file into the virtual machine. The configuration settings include a name for the virtual machine, a location for a page file associated with the virtual machine, and a storage area network policy associated with the virtual machine. The machine readable instructions are further configured to provision the image with the configuration settings from the file during the booting of the image to eliminate an additional reboot from occurring before the image completes booting and before the created virtual machine begins running the operating system.

In other features, the machine readable instructions are configured to receive the image prepared with device information associated with the virtual machine. The device information includes information about a hard disk drive and a network interface card associated with the virtual machine. The image includes device drivers according to the device information. The image prepared with device information eliminates device discovery and a subsequent reboot from occurring during the booting of the image.

In other features, the machine readable instructions are configured to receive the image prepared with device information associated with the virtual machine to eliminate device discovery and a subsequent reboot from occurring during the booting of the image. The device information includes information about a hard disk drive and a network interface card associated with the virtual machine. The image includes device drivers according to the device information. The machine readable instructions are further configured to eliminate an additional reboot from occurring, before the image completes booting and before the created virtual machine begins running the operating system, by provisioning the image with configuration settings associated with the virtual machine during the booting of the image. The configuration settings include a name for the virtual machine, a location for a page file associated with the virtual machine, and a storage area network policy associated with the virtual machine.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a cloud computing system that performs a virtual machine deployment using an image without rebooting the image.

FIG. 2 is an example of a sequence diagram of a virtual machine deployment performed by the cloud computing system of FIG. 1.

FIG. 3 is a functional block diagram of a simplified example of a distributed network system.

FIG. 4 is a functional block diagram of a simplified example of a client device used in the distributed network system of FIG. 3.

FIG. 5 is a functional block diagram of a simplified example of a server used in the distributed network system of FIG. 3.

FIG. 6 is a flow chart of a method for eliminating reboot of an image during a virtual machine deployment.

In the drawings, reference numbers may be reused to identify similar and/or identical elements.

### DESCRIPTION

The present disclosure relates to systems and methods for eliminating reboot during initial machine configuration of operating systems. While the systems and methods are described in the present disclosure with reference to cloud computing environment for example only, the teachings of the present disclosure apply equally to standalone and On-premise computer systems.

The present disclosure proposes the following approaches to eliminate the rebooting of an operating system (OS) image when a virtual machine is deployed for the first time to install the OS on a computer system. The rebooting can be eliminated by using any one of the following approaches or any combination of these approaches. The following is a brief description of these approaches. A detailed description of each approach follows.

A first approach involves employing an Initial Machine Configuration (IMC) technique and injecting configuration settings before starting a virtual machine (VM) on a host (e.g., a server in a cloud computing environment) as explained below in detail. The configuration settings are applied during a first boot of an operating system (OS) image used to create the VM. The configuration settings can be injected into the image using one of two methods: In a first method, an application program interface (API) available in the operating system is used to create a basic input/output system (BIOS) device, and the configuration data is stored in the BIOS device. Alternatively, in a second method, the OS image is configured through boot configuration data (BCD) (i.e., a firmware-independent database for boot-time configuration data) with appropriate IMC device and file name information, and an IMC hive file is stored in a disk attached to the VM. In each method, during the initial boot (i.e., the first boot) of the OS image, IMC hive data (and therefore the settings for computer name, page file, etc.) from the appropriate device (e.g., the disk attached to the VM or the BIOS device) are applied to the registry, and a reboot is eliminated. Accordingly, the OS image finishes installing the OS on the virtual machine without a single reboot, and the virtual machine is ready for use without a single reboot.

A second approach involves preparing the OS image by preserving the hardware information (e.g., using a system preparation (sysprep) VM mode explained below in detail) to avoid reboot due to device driver installation when the OS image boots for the first time. Since the hardware information is preserved, the hardware devices and corresponding device drivers are already installed, and reboot is eliminated during VM deployment. Accordingly, the OS image finishes installing the OS on the virtual machine without a single reboot, and the virtual machine is ready for use without a single reboot.

A third approach involves tuning the initial boot process to not start any non-whitelisted (i.e., non-out-of-the-box-experience (non-OOBE)) services that might trigger a reboot. For example, the non-OOBE services may be not be enabled, or may be delayed or configured to be completed after the OS installation is complete to avoid reboot. Accordingly, the OS image finishes installing the operating system on the virtual machine without a single reboot, and the virtual machine is ready for use without a single reboot.

In general, the systems and methods of the present disclosure are configured to boot an image of an operating system (OS) for creating a virtual machine (VM) to run the operating system, and to eliminate a reboot from occurring, before the image completes booting and before the created virtual machine begins running the operating system, by using one or more of the following approaches: provisioning the image with configuration settings associated with the virtual machine during the booting of the image, receiving the image prepared with device information associated with the virtual machine, and preventing a service other than predetermined services from starting during the booting of the image. These approaches are now described in detail.

Throughout the present disclosure, a name for the virtual machine, a location for a page file associated with the virtual machine, and a storage area network policy associated with the virtual machine are used as only examples of the configuration settings. The systems and methods of present disclosure can be used to update any and all registry settings. Further, throughout the present disclosure, information about a hard disk drive and a network interface card associated with the virtual machine and corresponding device drivers according to the device information are used only as examples of the device information. The device information may include other devices and drivers.

Typically, to deploy an image of an operating system (OS) to different computers, the image is first prepared. To prepare the image, a system preparation tool (e.g., sysprep) can be used. Alternatively, a setting in an answer file can be specified to prepare the image as part of an unattended installation. When preparing the image, any computer-specific information (e.g., information about hardware devices and corresponding device drivers) is removed from the image so that the image can be reused to install the operating system on many different computers. This process is called generalizing the image.

When a generalized virtual machine (VM) image is deployed in a cloud computing environment, the image goes through setup specialization, which includes setting machine-specific configuration supplied by the cloud fabric and tenant (customer). Some of these configuration settings cause the image to reboot, which impacts the time to deploy the VM. A tenant-supplied VM image cannot be modified offline in a host either due to security and privacy concern for the cloud computing environment.

Following are examples of configuration changes that occur during setup specialization, each of which causes the image to reboot: 1) Configuration settings such as computer name, page file location, and storage area network (SAN) policy are applied to the image. SAN allows a server to mount disks and other storage devices automatically from other computers, and SAN policy controls whether disks are automatically mounted, which disks can be mounted, and so on. 2) Devices are discovered during the initial booting of the image, and corresponding device drivers are installed. 3) Some actions during setup specialization of the image trigger some OS services to start, which are not allowed to run in an out-of-the-box-experience (OOBE) pass. To transition from specialization to OOBE pass, a reboot is required.

The systems and methods of the present disclosure address these issues and eliminate the reboot during image installation and VM deployment as follows. An Initial Machine Configuration (IMC) technique allows an OS instance to incorporate machine-specific configuration values during the initial booting of the image. The IMC technique allows a small registry hive file including machine-specific configuration settings to be consumed by a generic OS image during the initial boot, resulting in a machine-specific OS instance running which does not require additional configuration or reboot. This avoids the need for any offline processing of the image in the cloud computing environment.

More specifically, the configuration data that would normally be applied to a booting OS image, which may necessitate a reboot, is passed into a startup portion of the OS image via a registry hive file through synthetic BIOS or through pre-operating system components. The settings in the configuration data are applied to the OS image before the OS image enters a run state so that the OS image has those settings in effect the first time the OS image enters the run state while booting. Since the settings are already applied, the OS image does not need to reboot for those settings to take effect.

In addition to the IMC tool, the image can be prepared so as to preserve the computer-specific information (e.g., information about hardware devices and corresponding device drivers). For example, the image can be prepared using sysprep VM mode. This allows the VM image to be deployed back to the same virtualization environment in which the VM image was prepared. This can be useful to preserve image state and avoid extra steps during setup.

More specifically, when an image is typically created using sysprep and without using the VM mode, sysprep eliminates machine specific hardware configuration from the image so that the image contains no hardware profile and can be used to install the OS on any machine. When the image is booted for the first time on any other computer, the image discovers the hardware (e.g., hard disk, network interface card, etc.) installed on that computer during the initial boot process and loads corresponding drivers, which causes the image to reboot.

In contrast, according to the systems and methods of the present disclosure, an image created on a VM using VM mode preserves the hardware information of the VM on which the image is created. Since VMs generally have similar hardware configuration (e.g., same disk drives and same network interface cards), when the image created on a VM using VM mode is reused on another VM having similar hardware configuration, the discovery of hardware (e.g., disk drive, network interface card, etc.) and corresponding drivers, which normally causes reboot, is unnecessary since the image created using the VM mode already has that information preserved. Therefore, the hardware discovery is skipped, and reboot is avoided.

Accordingly, sysprep VM mode is used to generalize a virtual hard disk (VHD) image that is to be deployed on the same virtual machine or hypervisor. VM mode supports rapid deployment of virtual machines. VM mode is supported only when run from inside a virtual machine. VM mode cannot be used to prepare a VHD for deployment to any other computer.

In general, the IMC technique avoids reboot due to configuration changes. Further, the image prepared with hardware information preserved (e.g., using VM mode) avoids reboot due to hardware changes.

In addition, rebooting of the image due to non-OOBE or non-whitelisted services can be avoided as follows. A whitelisted service is a service for which there is no need for rebooting the image while the initial boot is in progress. Specialization expects certain OS services to be running. If specialization ends with only those services running, specialization assumes that nothing has changed in terms of OS services. If specialization notices any other service running, the image reboots. This situation can be countered as follows. Actions that enable non-whitelisted services can be configured to be performed (i.e., tuned) using alternate ways (e.g., delaying some initialization actions, delaying error messaging, etc.) so that these services are not enabled, and reboot is avoided.

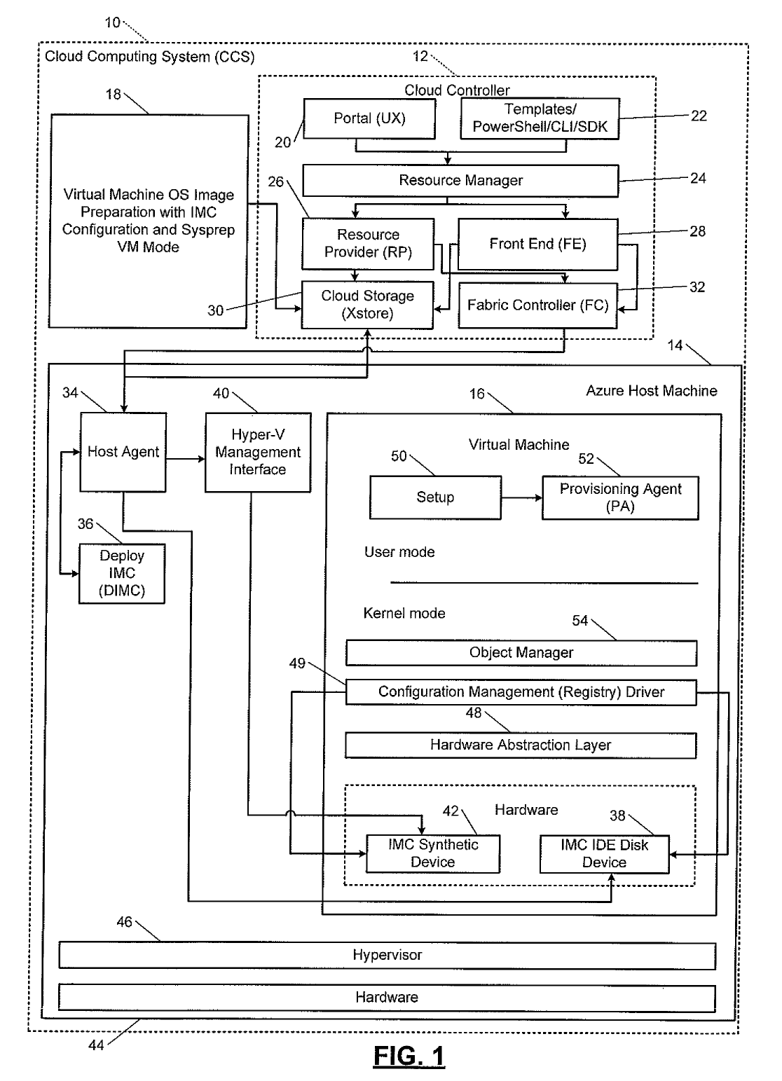

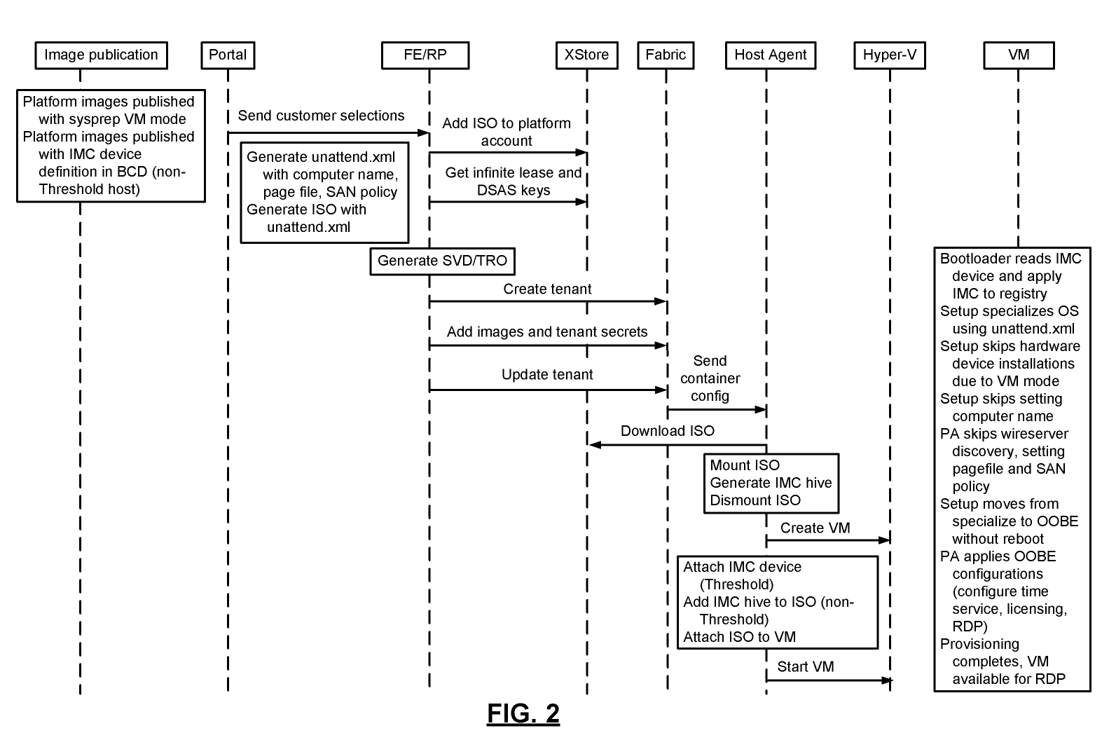

The systems and methods of the present disclosure, including the three approaches explained above, are now described below in further detail with reference to FIGS. 1 and 2. FIGS. 1 and 2 show only an example implementation of the systems and methods of the present disclosure. For example, a cloud computing system is used only as an example. The present disclosure is not limited to a cloud computing environment and is not limited to the following description of FIGS. 1 and 2. Rather, the following description of FIGS. 1 and 2 provides an example implementation of the systems and methods of the present disclosure in the context of a cloud computing environment, and the teachings apply equally to standalone and On-premise computer systems. Before describing FIGS. 1 and 2, some of the terms shown in FIGS. 1 and 2 and used in the description of FIGS. 1 and 2 are first described below.

A cloud computing system (CCS) is an infrastructure for building, deploying, and managing applications and services through a global network of managed data centers. The CCS provides services including software-as-a-service (SaaS), platform-as-a-service (PaaS), and infrastructure-as-a-service (IaaS) and supports many different programming languages, tools, and frameworks including third-party software and systems. SaaS is a software licensing and delivery model in which software is licensed on a subscription basis and is centrally hosted. PaaS allows developers to easily publish and manage Web sites. IaaS allows users to launch general-purpose multiple OS based virtual machines (VMs) and preconfigured machine images for popular software packages. Hyper-V is an example of a hypervisor on which multiple virtual machines can run, with the hypervisor controlling hardware and allocating resources to each VM's operating system.

An ISO image is an archive file of an optical disc, a type of disk image composed of data from every written sector on an optical disc, including the optical disc file system. ISO image files usually have a file extension of .iso. The name ISO is taken from the ISO 9660 file system used with CD-ROM media. An ISO image might also contain a universal disk format (UDF) (ISO/IEC 13346) file system (commonly used by DVDs and Blu-ray Discs). ISO images can be created from optical discs by disk imaging software, or from a collection of files by optical disc authoring software, or from a different disk image file by using conversion. As used herein, an image is an ISO image.

A boot configuration data (BCD) store is a firmware-independent data store that contains boot configuration data. The BCD store defines how boot menu is configured. The BCD store is a namespace container for BCD objects and elements that hold the information that is required to load the OS or run other boot applications. Physically, a BCD store is a binary file in the registry hive format. These BCD stores exist in a folder that contains the boot image.

A registry is a hierarchical database that stores low-level settings for an operating system (OS) and for applications that opt to use the registry. The OS kernel, device drivers, services, and user interface can all use the registry. In simple terms, the registry contains information, settings, options, and other values for programs and hardware installed on all versions of operating systems. For example, when a program is installed, a new subkey containing settings like a program's location, its version, and how to start the program, are all added to the registry.

The registry includes two basic elements: keys and values. Registry keys are container objects similar to folders. Registry values are non-container objects similar to files. Keys may contain values or further keys. The hierarchy of registry keys can only be accessed from a known root key handle that is mapped to the content of a registry key preloaded by the kernel from a stored hive, or to the content of a subkey within another root key, or mapped to a registered service or DLL that provides access to its contained subkeys and values. A hive or registry hive is a logical group of keys, subkeys, and values in the registry that has a set of supporting files containing backups of its data.

FIGS. 1 and 2 are now described in detail. FIG. 1 shows an example of a cloud computing system (CCS) 10 according to the present disclosure. The cloud computing system 10 includes a cloud controller 12 and a host machine 14. The cloud computing system 10 creates a virtual machine 16 on the host machine 14 as follows.

FIG. 2 shows an example of a sequence diagram of infrastructure-as-a-service virtual machine deployment performed by the cloud computing system 10 of FIG. 1. In FIGS. 1 and 2, cloud infrastructure is shown only as an example of a cloud computing system. The teachings of the present disclosure can be applied to any cloud infrastructure or cloud computing system.

The cloud controller 12 receives an operating system (OS) image for creating the virtual machine 16. The cloud controller 12 integrates customer's settings and cloud computing system's settings with the operating system image and delivers the operating system image to the host machine 14. FIG. 2 shows only one example of integrating customer's settings and cloud computing system's settings with the operating system image and delivering the operating system image to the host machine 14. Other methods of integrating the settings and delivering the operating system image are contemplated.

The operating system image 18 is prepared with sysprep VM mode. The image may also be pre-configured with IMC device definition in BCD. Using the cloud portal 20 and SDK 22, the customer sends customer selections (e.g., name for the virtual machine 16). The cloud computing system 10 determines other settings such as page file location and SAN policy. The cloud resource manager 24 forwards the customer selections to either the compute resource provider 26 of front end 28. The resource provider 26 or the front-end 28 then generates an installation answer file called unattend.xml with the computer name, page file, SAN policy; generates an ISO with the installation answer file; and adds the ISO to a CCS-owned storage account in the cloud storage 30.

The fabric controller 32 together with the resource provider 26 and the front end 28 provisions, stores, delivers, monitors, and commands the virtual machines (e.g., the virtual machine 16 created on the host machine 14). The fabric controller 32 has two primary objectives: to satisfy customer requests and policies, and to optimize and simplify deployment.

The host machine 14 creates the virtual machine 16 as follows. The host agent 34 downloads the ISO image from the cloud storage 30. The host agent 34 mounts the ISO image and generates the IMC hive registry by invoking a deploy IMC (DIMC) tool 36. The DIMC tool 36 takes the mounted path to the answer file in the ISO image as input and produces a registry hive file. The registry hive file contains the inputs for the customer's settings and cloud computing system's settings. The registry hive file is then injected into the virtual machine 16 using one of two methods as follows.

If the operating system image is a platform OS image (i.e., prepared and published by OS manufacturer), the image is published with BCD entries for IMC device and IMC hive file name. The host agent 34 copies the IMC hive file onto a resource disk 38. The IMC hive file is added to the resource disk 38. The resource disk 38 is attached to the virtual machine 16.

Alternatively, for platform image and custom image (i.e., image prepared by customer), the IMC hive file is injected into the virtual machine 16 by using a virtualization management interface 40. The virtualization management interface 40 uses an API to create an IMC synthetic device (e.g., synthetic BIOS) 42. The API also puts the data from IMC hive file onto this synthetic device.

The host machine 14 includes hardware 44 and a hypervisor 46 that runs on the hardware 44. The host machine 14 also has the host agent 34 which manages the lifecycle (e.g., create and start) of the virtual machine 16.

Once the virtual machine 16 is started by the host agent 34, during the boot process, operating system boot loader reads the IMC source disk 38 or the IMC synthetic device 42 (collectively the IMC device) containing the IMC hive data (the settings for computer name, page file, and SAN space policy) and applies them to the registry of the virtual machine 16 through the configuration management driver 49 and the object manager 54. The virtual machine 16 continues with the rest of the boot process. After the initial boot, the setup agent 50 runs. The setup agent 50 specializes the operating system being installed using the answer file on the ISO image.

The setup agent 50 skips hardware device detection and installation since the OS image was created using the VM mode, which eliminates rebooting. The setup agent 50 finds that the computer name is already applied to the registry, and therefore a reboot due to computer name is avoided. The setup agent 50 launches a provisioning agent 52, which attempts to configure page file and SAN policy settings. The provisioning agent 52 queries the registry for these settings through the object manager 54 and finds that these settings are already applied in the registry. Hence these settings are not set again, and a reboot is avoided.

The setup agent 50 tracks a list of whitelisted services that can run during the configuration process. If the setup agent 50 detects that a new service, which is not in the whitelist, is running, it triggers a reboot at the end of the current pass of the setup process (i.e., specialize pass). The provisioning agent 52 does not trigger start of any additional services while provisioning the virtual machine. Hence a reboot is avoided.

At this point, the virtual machine 16 is online and ready for use by the customer without any rebooting occurring during the first boot of the image. Accordingly, in general, the elimination of reboot due to configuration changes, hardware changes, and non-OOBE services can be performed as follows.

1) Elimination of reboot due to computer name, page file, and SAN policy: Customer inputs the computer name during VM deployment. The cloud computing system determines configuration settings such as page file location and SAN policy. Upon validation of computer name by a cloud computing system component, computer name, page file location, and SAN policy are put in an answer file (e.g. unattend.xml), which is put in an ISO image, and the ISO image is stored in a CCS-owned account. During the creation of the VM on the cloud computing system host node, a cloud computing system component downloads the ISO image, mounts the ISO image, and runs a tool (e.g., an OS-provided tool such as deploy IMC (DIMC)) to generate corresponding registry inputs for these configuration settings. The DIMC tool takes the mounted path to the answer file (e.g., the unattend file) in the ISO image as input and produces a registry hive file. The registry hive file is then injected into the VM by using one of two methods.

a) If the OS image is a platform OS image (i.e., an OS image prepared and published by the OS manufacturer), the OS image is published with BCD entries for IMC device and IMC hive file name. The registry hive file is copied onto a hard disk (e.g., an IDE disk (also known as cloud resource disk)), and the hard disk is attached to the VM.

b) For platform image and custom image (i.e., image prepared by customer), the IMC registry hive file is injected into the VM by using a hyper-V API. This API creates a synthetic BIOS device on the VM and puts the contents of the IMC registry hive file on this device. In each method, during the booting of the OS, the IMC registry hive file data (and therefore the settings for computer name, page file, and SAN policy) from the appropriate device is applied to the registry, and reboot is eliminated.

2) Elimination of reboot due to device driver installation: The customer prepares the OS image using sysprep VM mode. The VM mode allows the hardware device information to persist during sysprep generalization, which eliminates the need to reboot during VM deployment as hardware devices and device drivers are already installed.

3) Elimination of reboot due to non-OOBE services: Specialization actions that may run during OS setup specialization pass (e.g., the cloud provisioning agent) can trigger additional services to start in order to complete the actions. These services may not be whitelisted by the OS as a service that can run in OOBE pass. As a result, the OS normally requires a reboot of the image before moving from specialize pass to OOBE pass during the booting of the image. In the systems and methods of the present disclosure, by configuring or tuning these actions such that non-OOBE services are not required to complete those actions, non-OOBE services no longer start, and reboot is eliminated.

In this manner, the systems and methods of the present disclosure eliminate a reboot of the OS during initial machine configuration. With the application of IMC in a Virtual Machine along with sysprep VM mode technique for the Virtual Machine, eliminating the reboot results in faster deployment of the VM to the cloud environment, which makes the VM online and available to customer quickly. This improves the cloud computing system's operation and performance and also increases customer's satisfaction.

Below are simplistic examples of a distributed computing environment in which the systems and methods of the present disclosure can be implemented. Throughout the description, references to terms such as servers, client devices, applications and so on are for illustrative purposes only. The terms servers and client devices are to be understood broadly as representing computing devices comprising one or more processors and memory configured to execute machine readable instructions. The terms applications and computer programs are to be understood broadly as representing machine readable instructions executable by the computing devices.

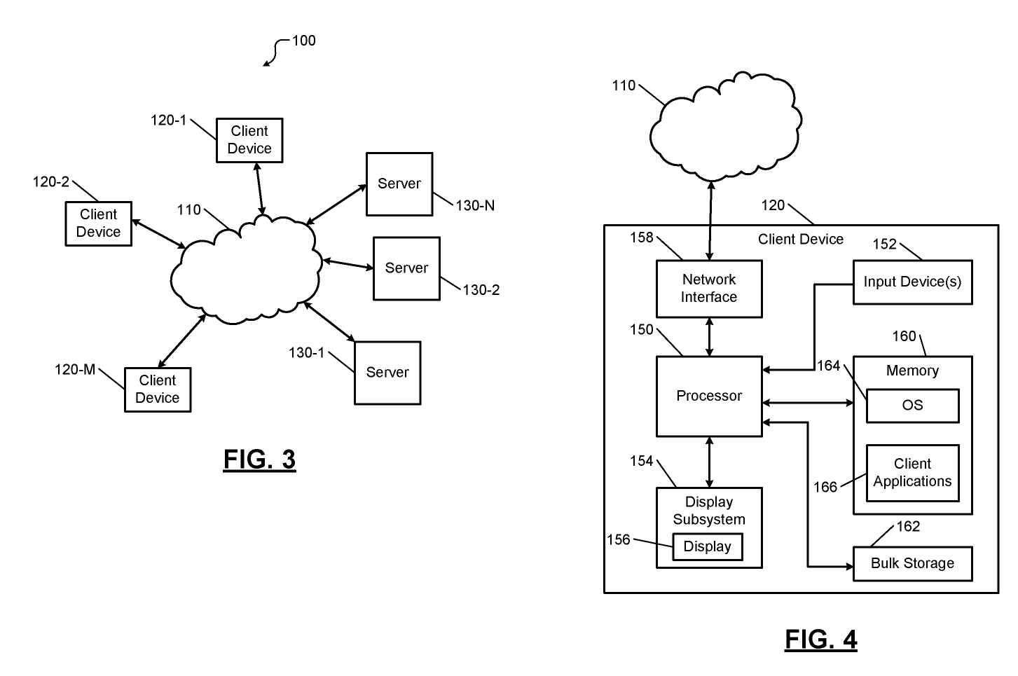

FIG. 3 shows a simplified example of a distributed network system 100. The distributed network system 100 includes a network 110, one or more client devices 120-1, 120-2, . . . , and 120-M (collectively client devices 120) (where M is an integer greater than or equal to one), and one or more servers 130-1, 130-2, . . . , and 130-N (collectively servers 130) (where N is an integer greater than or equal to one). The network 110 may include a local area network (LAN), a wide area network (WAN) such as the Internet, or other type of network including a cloud-based network (collectively shown as the network 110).

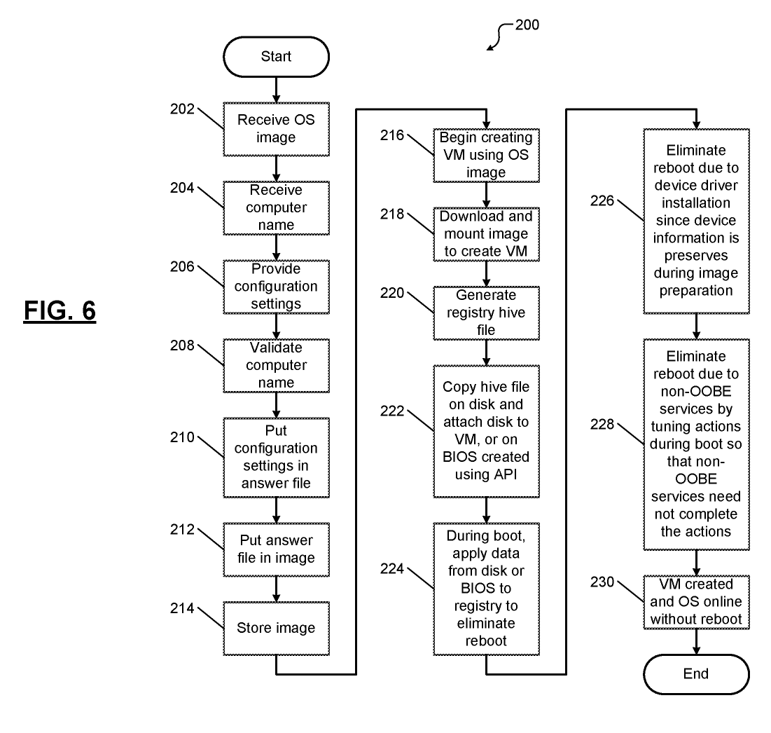

One or more of the servers 130 may operate to provide a cloud computing system such as the cloud computing system 10 described above with reference to FIGS. 1 and 2. One or more of the servers 130 may execute code or application (e.g., a method 200 shown in FIG. 6) to eliminate reboot during the initial installation of an OS image as described throughout the present disclosure. One or more of the servers 130 may also be located in different departments and different geographical locations of an enterprise.

The client devices 120 communicate with one or more of the servers 130 via the network 110. The client devices 120 and one or more of the servers 130 may connect to the network 110 using wireless and/or wired connections to the network 110. For example, the client devices 120 may include smartphones, personal digital assistants (PDAs), laptop computers, personal computers (PCs), and so on.

The servers 130 may provide multiple services to the client devices 120. For example, the servers 130 may execute a plurality of software applications developed by one or more vendors. The servers 130 may host multiple databases that are utilized by the plurality of software applications and that are used by users of the client devices 120.

FIG. 4 shows a simplified example of the client device 120. The client device 120 may typically include a central processing unit (CPU) or processor 150, one or more input devices 152 (e.g., a keypad, touchpad, mouse, and so on), a display subsystem 154 including a display 156, a network interface 158, a memory 160, and a bulk storage 162.

The network interface 158 connects the client device 120 to the distributed network system 100 via the network 110. For example, the network interface 158 may include a wired interface (e.g., an Ethernet interface) and/or a wireless interface (e.g., a Wi-Fi, Bluetooth, near field communication (NFC), or other wireless interface). The memory 160 may include volatile or nonvolatile memory, cache, or other type of memory. The bulk storage 162 may include flash memory, a hard disk drive (HDD), or other bulk storage device.

The processor 150 of the client device 120 executes an operating system (OS) 164 and one or more client applications 166. The client applications 166 include an application to connect the client device 120 to the server 130 via the network 110. The client device 120 accesses one or more applications executed by the server 130 via the network 110.

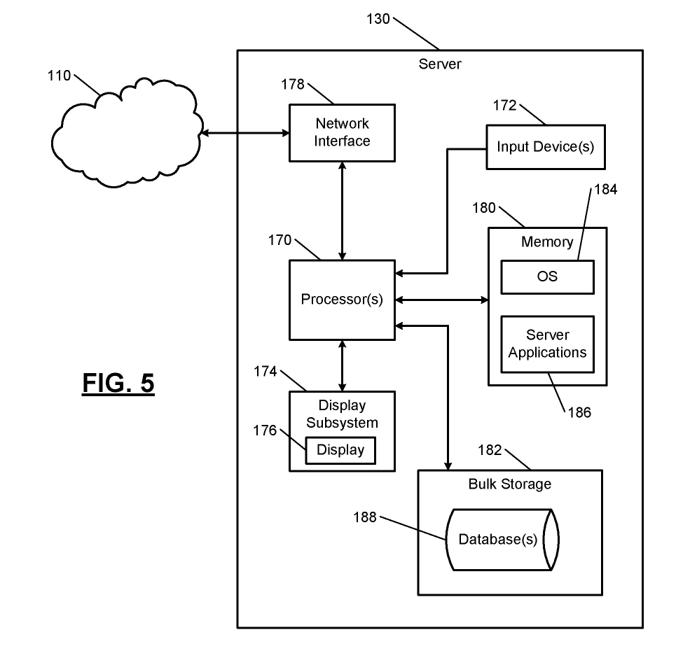

FIG. 5 shows a simplified example of the server 130. The server 130 typically includes one or more CPUs or processors 170, one or more input devices 172 (e.g., a keypad, touchpad, mouse, and so on), a display subsystem 174 including a display 176, a network interface 178, a memory 180, and a bulk storage 182.

The network interface 178 connects the server 130 to the distributed network system 100 via the network 110. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more hard disk drives (HDDs), or other bulk storage device.

The processor 170 of the server 130 executes an operating system (OS) 184 and one or more server applications 186, which include an application (e.g., a method 200 shown in FIG. 6) to eliminated reboot during initial installation of an OS image as described throughout the present disclosure. The bulk storage 182 may store one or more databases 188 that store data structures used by the server applications 186 to perform respective functions.

FIG. 6 shows a method 200 for elimination of reboot due to configuration changes, hardware changes, and non-OOBE services. As used herein, control refers to an application executed by one or more of the servers 130 shown in FIGS. 3 and 5 configured to boot an image of an OS for creating a virtual machine to run the OS, and to eliminate a reboot from occurring, before the image completes booting and before the created VM begins running the OS, by using one or more of the following approaches: provisioning the image with configuration settings associated with the VM during the booting of the image, receiving the image prepared with device information associated with the VM, and preventing a service other than predetermined services from starting during the booting of the image.

At 202, control receives an operating system image (OS image or ISO image) for creating a virtual machine in a cloud computing system (e.g., the cloud computing system 10 shown in FIG. 1). The operating system image may be a platform OS image (i.e., image prepared and published by the OS manufacturer) or custom image (i.e., image prepared by customer, preferably using VM mode). At 204, control receives an input including a computer name to be assigned to the virtual machine. At 206, control determines configuration settings for the OS including page file location and SAN policy. At 208, control validates the computer name. At 210, control puts the computer name and the configuration settings in an answer file (e.g., unattend.xml). At 212, control puts the answer file in the ISO image. At 214, control stores the ISO image in the cloud computing system (e.g., in manufacturer's account).

At 216, control begins creating the virtual machine on a host node of the cloud computing system using the OS image. At 218, control downloads and mounts the ISO image to create the virtual machine. At 220, control generates a registry hive file (e.g., by running a tool such as DIMC). At 222, control injects the registry hive file into the virtual machine by copying the registry hive file on a cloud resource disk (e.g., an IDE disk) and attaching the disk to the virtual machine if the OS image is a platform image, or on a synthetic BIOS created using an API (e.g., a hyper-v WMI API) if the OS image is a platform image or a custom image.

At 224, during the booting of the OS image, control applies the IMC registry hive file data from the disk or the BIOS to the registry to eliminate reboot that normally occurs due to configuration changes. At 226, control eliminates reboot that normally occurs due to device driver installation since device information is preserved during image preparation (e.g., by preparing the image using VM mode). At 228, control eliminates reboot due to non-OOBE services by tuning actions during boot such that the non-OOBE services are not required to complete those actions. Accordingly, the non-OOBE services do not start, and reboot is eliminated. At 230, the OS image finishes booting, the virtual machine is created, and the operating system installed on the virtual machine is online and ready for use in a single boot of the OS image (i.e., without any rebooting of the ISO image).

Accordingly, the systems and methods of the present disclosure are configured to boot an OS image for creating a virtual machine to run the OS and to eliminate a reboot from occurring, before the image completes booting and before the created virtual machine begins running the OS, by provisioning the image with configuration settings associated with the virtual machine during the booting of the image. For example, the configuration settings include a name for the virtual machine, a location for a page file associated with the virtual machine, and a SAN policy associated with the virtual machine.

Prior to booting the image, the systems and methods of the present disclosure are configured to generate a file based on the configuration settings associated with the virtual machine and inject the file into the virtual machine. The systems and methods are configured to store the file on a disk and attach the disk to the virtual machine, or to create a BIOS device on the virtual machine and store the file on the BIOS device. The systems and methods are configured to provision the image with the configuration settings from the file stored on the disk attached to the virtual machine or from the file stored on the BIOS device during the booting of the image.

The image is preferably prepared with the device information associated with the virtual machine preserved. For example, the device information includes information about a hard disk drive and a network interface card associated with the virtual machine. Accordingly, the image already includes device drivers according to the device information, and the image prepared with device information preserved eliminates device discovery and a subsequent reboot from occurring during the booting of the image.

The systems and methods are further configured to tune actions during the boot process to prevent a service other than predetermined services (i.e., other than whitelisted or OOBE services) from starting during the booting of the image to prevent the service from triggering an additional reboot of the image (e.g., by not enabling or by delaying completion of non-OOBE services, or by scheduling completion of non-OOBE services after the image finishes booting, VM is created, and OS is running on the VM).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term memory is a subset of the term computer-readable medium or machine-readable medium. The term computer-readable medium or machine-readable medium, as used herein, does not encompass transitory electrical or electromagnetic signals propagating through a medium (such as on a carrier wave); the term computer-readable medium or machine-readable medium may therefore be considered tangible and non-transitory. Non-limiting examples of a non-transitory, tangible computer-readable medium or machine-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTMLS (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system comprising:
a processor and memory; and
machine readable instructions stored in the memory, when executed by the processor, configured to:
boot an image of an operating system for creating a virtual machine to run the operating system; and
eliminate a reboot from occurring, before the image completes booting and before the created virtual machine begins running the operating system, by provisioning the image with configuration settings associated with the virtual machine during the booting of the image.

2. The system of claim 1 wherein the configuration settings include a name for the virtual machine, a location for a page file associated with the virtual machine, and a storage area network policy associated with the virtual machine.

3. The system of claim 1 wherein the machine readable instructions are configured to:
prior to booting the image of the operating system:
generate a file based on the configuration settings associated with the virtual machine; and
inject the file into the virtual machine; and
provision the image with the configuration settings from the file during the booting of the image.

4. The system of claim 1 wherein the machine readable instructions are configured to:
prior to booting the image of the operating system:
generate a file based on the configuration settings associated with the virtual machine;
store the file on a disk; and
attach the disk to the virtual machine; and
provision the image with the configuration settings from the file stored on the disk attached to the virtual machine during the booting of the image.

5. The system of claim 1 wherein the machine readable instructions are configured to:
prior to booting the image of the operating system:
generate a file based on the configuration settings associated with the virtual machine;
create a basic input/output device on the virtual machine; and
store the file on the basic input/output device on the virtual machine; and
provision the image with the configuration settings from the file stored on the basic input/output device on the virtual machine during the booting of the image.

6. The system of claim 1 wherein the machine readable instructions are configured to:
receive the image prepared with device information associated with the virtual machine,
wherein the device information includes information about a hard disk drive and a network interface card associated with the virtual machine,
wherein the image includes device drivers according to the device information, and
wherein the image prepared with device information eliminates device discovery and a subsequent reboot from occurring during the booting of the image.

7. The system of claim 1 wherein the machine readable instructions are configured to prevent a service other than predetermined services from starting during the booting of the image to prevent the service from triggering an additional reboot during the booting of the image.

8. The system of claim 1 wherein the machine readable instructions are configured to:
receive the image prepared with device information associated with the virtual machine to eliminate device discovery and a subsequent reboot from occurring during the booting of the image; and
prevent a service other than predetermined services from starting during the booting of the image to prevent the service from triggering an additional reboot during the booting of the image.

9. A method comprising:
booting an image of an operating system for creating a virtual machine to run the operating system; and
eliminating a reboot from occurring, before the image completes booting and before the created virtual machine begins running the operating system, by provisioning the image with configuration settings associated with the virtual machine during the booting of the image.

10. The method of claim 9 wherein the configuration settings include a name for the virtual machine, a location for a page file associated with the virtual machine, and a storage area network policy associated with the virtual machine.

11. The method of claim 9 further comprising:
prior to booting the image of the operating system:
generating a file based on the configuration settings associated with the virtual machine; and
injecting the file into the virtual machine; and
provisioning the image with the configuration settings from the file during the booting of the image.

12. The method of claim 9 further comprising:
prior to booting the image of the operating system:
generating a file based on the configuration settings associated with the virtual machine;
storing the file on a disk; and
attaching the disk to the virtual machine; and
provisioning the image with the configuration settings from the file stored on the disk attached to the virtual machine during the booting of the image.

13. The method of claim 9 further comprising:
prior to booting the image of the operating system:
generating a file based on the configuration settings associated with the virtual machine;
creating a basic input/output device on the virtual machine; and
storing the file on the basic input/output device on the virtual machine; and
provisioning the image with the configuration settings from the file stored on the basic input/output device on the virtual machine during the booting of the image.

14. The method of claim 9 further comprising:
receiving the image prepared with device information associated with the virtual machine,
wherein the device information includes information about a hard disk drive and a network interface card associated with the virtual machine,
wherein the image includes device drivers according to the device information, and
wherein the image prepared with device information eliminates device discovery and a subsequent reboot from occurring during the booting of the image.

15. The method of claim 9 further comprising preventing a service other than predetermined services from starting during the booting of the image to prevent the service from triggering an additional reboot during the booting of the image.

16. The method of claim 9 further comprising:
receiving the image prepared with device information associated with the virtual machine to eliminate device discovery and a subsequent reboot from occurring during the booting of the image; and
preventing a service other than predetermined services from starting during the booting of the image to prevent the service from triggering an additional reboot during the booting of the image.

17. A system comprising:
a processor and memory; and
machine readable instructions stored in the memory, when executed by the processor, configured to:
prior to booting an image of an operating system for creating a virtual machine to run the operating system:
generate a file based on configuration settings associated with the virtual machine, wherein the configuration settings include a name for the virtual machine, a location for a page file associated with the virtual machine, and a storage area network policy associated with the virtual machine; and
inject the file into the virtual machine; and
provision the image with the configuration settings from the file during booting of the image to eliminate a reboot from occurring before the image completes booting and before the created virtual machine begins running the operating system.

18. The system of claim 17 wherein the machine readable instructions are configured to:
prior to booting the image of the operating system:
store the file on a disk; and
attach the disk to the virtual machine; and
provision the image with the configuration settings from the file stored on the disk attached to the virtual machine during the booting of the image.

19. The system of claim 17 wherein the machine readable instructions are configured to:
prior to booting the image of the operating system:
create a basic input/output device on the virtual machine; and
store the file on the basic input/output device on the virtual machine; and
provision the image with the configuration settings from the file stored on the basic input/output device on the virtual machine during the booting of the image.

20. The system of claim 17 wherein the machine readable instructions are configured to:
receive the image prepared with device information associated with the virtual machine to eliminate device discovery and a subsequent reboot from occurring during the booting of the image; and
prevent a service other than predetermined services from starting during the booting of the image to prevent the service from triggering an additional reboot during the booting of the image.
